(19) United States
(12) Patent Application Publication
(10) Pub. No.: US 2004/0241283 A1
(43) Pub. Date: Dec. 2, 2004

(54) Method of preventing discoloration of dough, dough compositions, and dough products

(76) Inventors: David J. Domingues, Plymouth, MN (US); David A. Kirk, Coon Rapids, MN (US)

Correspondence Address: KAGAN BINDER, PLLC, Maple Island Building, Suite 200, 221 Main Street North, Stillwater, MN, 55082, US

(21) Appl. No.: 10/446,483

(22) Filed: May 28, 2003

(51) Int. Cl. A23L 1/10

(52) U.S. Cl. 426/18

(57) ABSTRACT

Described are dough compositions, dough products, and related methods for preventing discoloration of dough compositions, including particular embodiments involving a packaged dough product suitable for storage under low pressure conditions, and embodiments wherein the dough comprises an oxidoreductase enzyme such as glucose oxidase, and optionally catalase.

### FIELD OF THE INVENTION

The invention relates to dough compositions, packaged dough products, and methods of preventing enzymatic discoloration of a dough composition.

### BACKGROUND

Processing and storage of food products can be problematic because of the possibility of discoloration, such as discoloration caused by enzymatic oxidation reactions. The discoloration of freshly cut apples is an example of a discoloring oxidation reaction.

An example of a discoloration problem with dough products is the graying of a dough surface believed to be caused by the enzyme-catalyzed oxidation of phenolic and or fatty acids compounds naturally present in wheat flour. One such enzymatic reaction is the polyphenol oxidase-catalyzed oxidation of native wheat flour phenolic compounds into orthoquinones. The orthoquinones rapidly polymerize to form brown pigments or melanins. Another proposed mechanism is the creation, and subsequent oxidation, of free fatty acids by the enzymes lipase and lipoxygenase (native to wheat flour). The oxidized free fatty acids react with and “bleach” the native wheat flour carotenoids thereby rendering the dough translucent (i.e., gray). These oxidation reactions occur as a result of the presence of oxygen either inherently in a dough composition or as a result of oxygen present in the atmosphere surrounding the dough, e.g., “headspace” inside of a dough product package.

Methods of reducing or inhibiting discoloration caused by oxidation of food products in storage often attempt to control the presence of oxygen, i.e., reduce its presence. Air that is present in our environment contains about 19-21% oxygen (O₂). One technique to avoid discoloration is to package a food product in a controlled atmosphere, e.g., an atmosphere that contains less oxygen than does air. By this method, the air that would surround a packaged food product is flushed with an inert gas such as nitrogen. This technique can be time consuming and expensive on a commercial scale.

Another known oxygen removal technique involves the inclusion of oxygen scavengers such as silica or ferrous materials that react preferentially with the oxygen. For example, a ferrous material or a silica material may be enclosed in a separate package within the food product (e.g., a sachet) to ensure that ferrous or silica material does not contact the food product. It is generally accepted in the food industry that such packages, which are typically small in nature, are considered choking hazards as well as being quite expensive.

There is an ongoing general need to address problems of food discoloration. Specifically, there is benefit in identifying new methods of inhibiting food discoloration and in identifying new food compositions and packaged food products that are less susceptible to discoloration.

### SUMMARY

Various enzymes have been used in dough compositions for a variety of reasons, for example to improve rheological properties (e.g., to strengthen a dough). The present invention relates to the use of oxidoreductase enzymes to inhibit discoloration of a dough. The invention is particularly applicable to packaged raw dough products (e.g., products that include a dough composition in a substantially airtight package) that are intended to be stored prior to being baked, and which therefore can be susceptible to enzymatic discoloration if stored in the presence of an amount of oxygen.

Generally, enzymatic discoloration of a dough composition can occur upon the enzymatic oxidation of a material (e.g., compound) present in the dough composition or an ingredient (e.g., a phenolic compound or free fatty acid). By one theorized mechanism, an enzyme found in wheat (e.g., flour), polyphenol oxidase, can react with oxygen to produce a pigment that may cause a gray discoloration at the dough surface. By another theorized mechanism, free fatty acids are generated in the dough and oxidized, in the presence of oxygen, by the enzymes lipase and lipoygenase. The oxidized fatty acids in turn react with and “bleach” native wheat flour carotenoids thereby rendering the dough translucent and gray in appearance.

Removal of oxygen from the environment of a dough surface can prevent enzymatic discoloration reactions. A feature of the invention relates to the removal of oxygen, e.g., reduction of an amount of oxygen, from a dough composition environment by reaction of the oxygen with an oxidoreductase enzyme and a substrate. The enzyme can be present in the dough composition itself (e.g., throughout the dough), or may be present at only a surface or a portion of a dough composition, or may be otherwise present in a packaged dough product at a location where the enzyme can remove oxygen from the environment of the packaged dough product surface. Specific embodiments of the invention relate, e.g., to packaged dough products that include an oxidoreductase enzyme and a substrate. The substrate, in the presence of the oxidoreductase enzyme can react with oxygen (O₂) to consume the oxygen and prevent the oxygen from participating in an enzymatic discoloration reaction. One specific embodiment relates to glucose-containing dough compositions, wherein the dough composition or the package includes the oxidoreductase enzyme glucose oxidase. The glucose and oxygen react in the presence of the glucose oxidase, consuming oxygen, and preventing that oxygen from participating in a discoloring enzymatic reaction that would cause, e.g., a gray color.

In particular embodiments of the invention, a dough composition or a packaged dough product can include an additional enzyme, in addition to the oxidoreductase enzyme, to prevent discoloration caused by hydrogen peroxide. Hydrogen peroxide can be a by-product of a reaction to remove oxygen from a dough environment. The hydrogen peroxide may potentially produce a yellowish color. The invention relates to the optional presence, in a dough composition or packaged dough product, of an enzyme to remove hydrogen peroxide and inhibit or prevent discoloration caused by the hydrogen peroxide. An example of such an enzyme is catalase.

A dough composition of the invention may be yeast-leavenable or chemically-leavenable, and may be pre-proofed or unproofed. A dough composition may be packaged in a low pressure flexible packaging material with headspace, in a pressurized canister-type or can-type package, or in any other substantially airtight package. Exemplary embodiments include dough products that include a raw dough composition in a flexible package with a conventional amount of headspace, or an amount of headspace that has been reduced (e.g., by vacuum).

Certain embodiments of the invention contemplate packaged raw, un-proofed, chemically-leavenable dough compositions that are refrigerator stable, evolving relatively low amounts of carbon dioxide during refrigerated storage, e.g., chemically-leavenable dough compositions that evolve less than approximately 70 cubic centimeters (cc) of carbon dioxide per 126 grams (g) of dough composition over 12 weeks at refrigerated storage temperature (e.g., 45 degrees Fahrenheit), preferably less than 50 cc or 40 cc of carbon dioxide per 126 g of dough over 12 weeks at 45 degrees Fahrenheit.

Preferred embodiments of dough compositions and dough products can exhibit anti-graying properties as measured by analytic color measuring techniques. For example, 126 gm (approximately 126 cubic centimeters) of a preferred dough composition may exhibit a color value of greater than or equal to 75 according to the Minolta L test, after storage for 2 weeks at 40 degrees Fahrenheit when packaged in a package containing 35 cubic centimeters (cc) headspace, the headspace containing less than or equal to one percent oxygen by volume. Even more preferably, the measured color value can be greater than or equal to 75 after 4 weeks or after 12 weeks at such conditions. Individual and relative coloration measurements of a dough composition can be made using known methods and color measuring equipment, such as a Minolta calorimeter (Chroma meter CR-300).

The invention also relates to methods of preparing dough compositions and dough products that are resistant to graying. The methods may include providing a dough composition comprising water, flour, and leavening agent, and including in the packaged dough product an amount of oxidoreductase enzyme to inhibit discoloration of the dough due to enzymatic oxidation. The enzyme may be present in the dough, at a dough surface, or may be otherwise inside of the packaged dough product. The method may optionally also include reducing the amount of oxygen present inside of the package, e.g., by purging headspace inside of the container with an inert gas or by reducing the amount of headspace.

Advantageously, the invention can simplify processing of a packaged dough product by increasing the tolerance for oxygen in a package headspace. Without the use of an oxidoreductase enzyme, the amount of oxygen that may be tolerated in a package headspace at the time of packaging, without causing eventual graying of a packaged dough composition, might be quite low, e.g., below 0.5 percent (by volume) for 126 grams of dough package in a container with 35 cc headspace gas. The invention advantageously allows for oxygen to be removed from packaging headspace by a reaction that involves oxygen and an oxidoreductase enzyme. With the oxidoreductase enzyme in the packaged dough product, the amount of oxygen that may be tolerated in a headspace at the time of packaging may be higher than if the oxidoreductase enzyme were not part of the packaged dough products e.g., 1 to 2 percent (by volume), as compared to less than 0.5 percent (for 126 gm dough package in a container with 35 cc headspace). A tolerance for relatively larger concentrations of oxygen in the headspace can allow for processing efficiencies, e.g., higher line speeds. Furthermore, if one can reduce the total moles of oxygen present in the product and package system to a level at which graying will not occur, such as by vacuum packaging, nitrogen purging may no longer be required.

A glucose oxidase activity unit is defined as the amount of enzyme causing the oxidation of 1 micromole of glucose per minute at 25° C. and at pH 7.0.

A catalase activity unit is defined as the amount of enzyme which under standard conditions of 25° C. and at pH 7.0 decomposes 1 micromole of H₂O₂ per minute.

An aspect of the invention relates to a dough product comprising raw dough inside a package, the dough product comprising an oxidoreductase enzyme and a substrate that reacts with oxygen in the presence of the oxidoreductase enzyme, in amounts to consume oxygen to inhibit enzymatic discoloration of the dough.

Another aspect of the invention relates to a chemically leavenable dough comprising an oxidoreductase enzyme and a substrate that reacts with oxygen in the presence of the oxidoreductase enzyme, packaged in a low pressure container.

Yet another aspect of the invention relates to a method of preparing a packaged dough product. The method includes providing a dough composition comprising water, flour, and leavening agent, and including in the dough product an oxidoreductase enzyme and a substrate that reacts with oxygen in the presence of the oxidoreductase enzyme. The oxidoreductase enzyme and substrate consume oxygen and inhibit discoloration of the dough due to enzymatic oxidation.

### BRIEF DESCRIPTION IF THE DRAWINGS

FIG. 1 illustrates graphically the results of percent oxygen (by volume) in the headspace gas of a container over time on dough (gray) color formation.

FIGS. 2, 3 illustrate graphically the Minolta “b” value with varying enzyme concentration and vacuum packaging conditions over shelf life time.

### DETAILED DESCRIPTION

The dough composition can include any type or formulation of yeast or chemically leavenable or leavened dough that when packaged and stored is susceptible to enzymatic discoloration due to oxidation. Many if not all formulations of yeast and chemically leavenable dough compositions contain ingredients that can react with oxygen in the presence of an enzyme to 1) produce a pigment that would result in a grayish dough color appearance during refrigerated or frozen storage, or 2) oxidize native carotenoid pigments during refrigerated or frozen storage to result in a grayish dough appearance. The invention can reduce or prevent such discoloration, by reducing the amount of oxygen available for such discoloring enzymatic oxidation reactions.

The dough composition can be prepared from ingredients generally known in the dough and bread-making arts, typically including flour, a liquid component such as oil or water, sugar (e.g., glucose), a yeast or chemical leavening system, and optionally additional ingredients such as shortening, salt, dairy products, egg products, processing aids, emulsifiers, particulates, dough conditioners, yeast as a flavorant, other flavorings, etc. Dough formulations are known to those skilled in the dough and baking arts and are readily available to the public in commercial cookbooks.

A flour component can be any suitable flour or combination of flours, including glutenous and nonglutenous flours, and combinations thereof. The flour or flours can be whole grain flour, wheat flour, flour with the bran and/or germ removed, or combinations thereof. Typically, a dough composition can include between about 30% and about 70% by weight flour, e.g., from about 40% to about 60% by weight flour, such as from about 45 to 55 weight percent flour.

Examples of liquid components include water, milk, eggs, and oil, or any combination of these. Preferably, a liquid component may include water, e.g., in an amount in the range from about 15 to 35 weight percent, although amounts outside of this range may also be useful. Water may be added during processing in the form of ice, to control the dough temperature in-process; the amount of any such water used is included in the amount of liquid components. The amount of liquid components included in any particular dough composition can depend on a variety of factors including the desired moisture content of the dough composition. Typically, liquids can be present in a dough composition in an amount between about 15% by weight and about 35% by weight, e.g., between about 20% by weight and about 30% by weight.

The dough composition can optionally include egg or dairy products such as milk, buttermilk, or other milk products, in either dried or liquid forms. Non-fat milk solids which can be used in the dough composition can include the solids of skim milk and may include proteins, mineral matter, and milk sugar. Other proteins such as casein, sodium caseinate, calcium caseinate, modified casein, sweet dairy whey, modified whey, and whey protein concentrate can also be used in these doughs. If used, dairy products can be included as up to about 25 percent by weight of the dough composition, e.g., between about 1 percent and about 10 percent of the dough composition.

The dough composition can optionally include fat ingredients such as oils and shortenings. Examples of suitable oils include soybean oil, corn oil, canola oil, sunflower oil, and other vegetable oils. Examples of suitable shortenings include animal fats and hydrogenated vegetable oils. If included, fat is typically used in an amount less than about 20 percent by weight, often less than 15 percent by weight of the dough composition.

The dough composition can optionally include one or more sweeteners, either natural or artificial, liquid or dry. Examples of suitable dry sweeteners include lactose, sucrose, fructose, dextrose, maltose, corresponding sugar alcohols, and mixtures thereof. Examples of suitable liquid sweeteners include high fructose corn syrup, malt, and hydrolyzed corn syrup. Often, dough compositions include between about 2% by weight and about 15% by weight, e.g., from about 5% by weight to about 10% by weight sweetener.

The dough composition can further include additional flavorings, for example, salt, such as sodium chloride and/or potassium chloride; whey; malt; yeast extract; yeast (e.g., inactivated yeast); spices; vanilla; etc.; as is known in the dough product arts. Other examples of dry or liquid flavoring agents include fruit and vegetables, mustard, potatoes, anchovies, capers, olives, bacon, cocoa, vanilla, chocolate, butter flavour, coconut, peppermint, pineapple, cherry, nuts, spices, salts, poppy or sesame seeds, onion, garlic, cheese, tomatoes, scallions, oat bran, jalapeno, peppers, cinnamon, raisins, chocolate chips, apples, berries, bananas, walnuts, lemon and flavour enhancers. The additional flavoring can typically be included in an amount in the range from about 0.1 percent to about 10 percent of the dough composition, e.g., from about 0.2 percent to about 5 percent of the dough composition.

As is known, dough compositions can also optionally include other additives, colorings, and processing aids such as emulsifiers, strengtheners (e.g., ascorbic acid), preservatives, and conditioners. Suitable emulsifiers include lecithin, mono- and diglycerides, polyglycerol esters, and the like, e.g., diacetylated tartaric esters of monoglyceride (DATEM) and sodium stearoyl-2-lactylate (SSL). Acidulants commonly added to food foods include lactic acid, citric acid, tartaric acid, malic acid, acetic acid, phosphoric acid, and hydrochloric acid.

Conditioners, as are known in the dough products art, can be used to make the dough composition tougher, drier, and/or easier to manipulate. Examples of suitable conditioners can include azodicarbonamide, potassium sulfate, potassium sorbate, L-cysteine, L-cysteine hydrochloride, sodium bisulfate, mono- and di-glycerides, polysorbates, sodium bisulfite, sodium stearoyl lactylate, ascorbic acid and diacetyltartaric acid esters of mono- and di-glycerides (DATEM), and the like. These conditioners may add functionality, reduce mix times, and provide softness to the doughs to which they are added.

The dough composition includes a substrate that can react with oxygen in the presence of an oxidoreductase enzyme, to consume oxygen and prevent the oxygen from being available to react to discolor the dough composition. The particular substrate and amount used can depend on various factors relating to the dough composition and packaged dough product, in particular, on the oxidoreductase enzyme that is selected.

Oxidoreductase enzymes are generally known, and are described, for example, at Whitaker, John R., Principles of Enzymology for the Food Sciences, 2^{nd} Ed., Chapters 21-27, p. 517 et. seq. Examples of oxidoreductase enzymes include glucose oxidase and lactate dehydrogenase, among many others.

If the oxidoreductase enzyme is glucose oxidase, the substrate can be a glucose. Glucose is a monosaccharide sugar also known as D-glucose, D-glucopyranose, grape sugar, corn sugar, dextrose, and cerelose. The chemical representation of glucose is shown below.

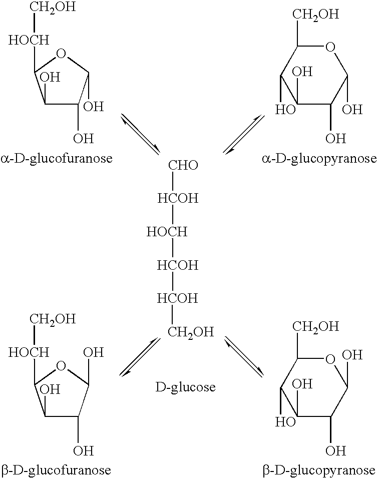

Glucose (or any other substrate that reacts with oxygen in the presence of an oxidoreductase enzyme) can be present in a dough composition as a separately added ingredient, e.g., as a sweetener or other additive, or may be contained in one of the other ingredients included in the dough composition. The amount of the substrate in a dough composition of the invention can be any amount that in combination with an oxidoreductase enzyme (e.g., glucose oxidase) results in the depletion of oxygen within the dough composition or packaged dough product to the extent that the extent of dough discoloration (e.g., graying) is reduced or eliminated upon subsequent refrigerated or frozen storage prior to being baked. Exemplary amounts of glucose may be in the range from about 1 to about 40 percent (Baker's percent), e.g., from about 5 to about 30 Baker's percent.

The dough composition can be yeast-leavenable or chemically-leavenable, refrigerator or freezer stable, proofed or unproofed. For example, an embodiment of the invention includes a chemically-leavenable, refrigerator stable, unproofed dough composition. A chemical leavening system generally includes a basic chemical leavening agent and an acidic chemical leavening agent, the two of which react to produce a leavening gas (e.g., carbon dioxide), to leaven the dough composition.

Acidic chemical leavening agents are generally known in the dough and bread-making arts, and include sodium aluminum phosphate (SALP), sodium acid pyrophosphate (SAPP), and monosodium phosphate; monocalcium phosphate monohydrate (MCP), anhydrous monocalcium phosphate (AMCP), dicalcium phosphate dihydrate (DCPD) as well as a variety of others. Commercially available acidic chemical leavening agents include those sold under the trade names: Levn-Lite® (SALP), Pan-O-Lite® (SALP+MCP), STABIL-9® (SALP+AMCP), PY-RAN® (AMCP), and HT® MCP (MCP). These and other examples of acidic chemical leavening agents useful in dough compositions are described in Assignee's copending U.S. patent application Ser. No. 09/945,204, filed Aug. 31, 2001, entitled “Chemically Leavened Doughs and Related Methods,” and in U.S. Pat. No. 6,261,613, the entire disclosures of which are incorporated herein by reference.

The amount of acidic chemical leavening agent included in a dough composition can be an amount sufficient to neutralize an amount of basic chemical leavening agent, e.g., an amount that is stoichiometric to the amount of basic chemical leavening agent, with the exact amount being dependent on the particular acidic chemical leavening agents that is chosen. A typical amount of acidic agent such as SALP may be in the range from about 0.25 to about 2 parts by weight per 100 parts dough composition, with ranges from about 0.25 to about 1.5 parts by weight per 100 parts dough composition sometimes being preferred.

Useful basic chemical leavening agents are generally known in the dough and baking arts, and include soda, i.e., sodium bicarbonate (NaHCO₃), potassium bicarbonate (KHCO₃), ammonium bicarbonate (NH₄HCO₃), etc. These and similar types of basic chemical leavening agent can be generally soluble in an aqueous phase of a dough composition at processing or refrigerated storage temperature.

The amount of a basic chemical leavening agent to be used in a dough composition is preferably sufficient to react with the included acidic chemical leavening agent to release a desired amount of gas for leavening, thereby causing a desired degree of expansion of the dough product. As will be appreciated by the skilled artisan, the individual acidic and basic agents can be included in a dough composition in respective amounts that are useful to leaven the dough composition. Typical amounts of a basic chemical leavening agent may be in the range from about 0.25 to about 2 parts by weight per 100 parts dough composition, with ranges from about 0.75 to about 1.5 parts by weight 100 parts dough composition being preferred.

In certain embodiments of the invention, a chemical leavening agent (e.g., the basic chemical leavening agent) may be encapsulated, as discussed in Assignee's copending U.S. patent application Ser. No. 09/945,204, filed Aug. 31, 2001, entitled “Chemically Leavened Doughs and Related Methods,” and in U.S. Pat. No. 6,261,613.

The invention can be particularly useful with raw packaged dough compositions designed to be stable for storage in a container for a period of time, and wherein one or more of the dough composition or the package includes some amount of oxygen that could react enzymatically with the dough composition to cause discoloration of the dough composition. The packaged dough product may be designed for storage at frozen or refrigerated conditions. The package may or may not include headspace. A packaged dough product that includes headspace may include oxygen in the dough composition, and may additionally include oxygen in the headspace (i.e., the volume within the package that is not taken up by dough product or another solid material). The oxygen in the headspace can arise from two sources. The oxygen can be released slowly from the dough composition into the headspace over time (e.g., released from entrapped or entrained oxygen incorporated into the dough upon mixing and forming) or oxygen may be present in the original headspace atmosphere surrounding the packaged dough composition, e.g., at from about 20.9% (by volume) oxygen for atmospheric air to lesser residual amounts of (1-5% by volume) remaining in the headspace subsequent to optional flushing with nitrogen gas. Headspace in a flexible film package may be reduced by subjecting the packaged product to a vacuum (<5 mb) prior to back flushing the chamber with an inert gas, such as nitrogen, e.g., to a pressure of <1000 mb. The extent of back flushing can determine the volume of headspace gas surrounding the product. A packaged dough product that includes little or no headspace, e.g., a refrigerator-stable pressurized canister, may include oxygen contained in the dough composition within the package.

By one proposed mechanism, enzymatic discoloration of a dough composition, especially a packaged dough composition stored at refrigerated or frozen temperatures, can occur upon the enzymatic oxidation of a compound present in the dough composition (e.g., a phenolic compound), in the presence of oxygen. By one theorized mechanism, an enzyme found in wheat (e.g., flour), polyphenol oxidase, can cause the reaction between oxygen and phenolic compounds (also present, e.g., in wheat flour) to produce a pigment that may cause a gray discoloration at the dough surface. Another purposed mechanism is the creation and subsequent oxidation of free fatty acids by the enzymes lipase and lipoxygenase (native to wheat flour). The oxidized free fatty acids react with and “bleach” the native wheat flour carotenoids thereby rendering the dough translucent (i.e., gray).

According to the invention, an oxidoreductase enzyme is included in a packaged dough composition to prevent or reduce enzymatic discoloration of a dough composition. The enzyme can be included in the dough composition itself, in only a portion of the dough composition such as at a surface, or elsewhere in a packaged dough composition at a location effective to inhibit or prevent discoloration. The oxidoreductase enzyme can be any enzyme that effectively causes a non-discoloring reaction between oxygen and a substrate to consume oxygen within the dough composition or packaged dough product and prevent the oxygen from otherwise reacting to cause discoloration of the dough composition. A preferred example of a useful oxidoreductase enzyme is glucose oxidase.

Glucose oxidase is an enzyme that catalyzes the reaction of glucose in the presence of oxygen and water to produce hydrogen peroxide. The chemical reaction can be represented as follows:

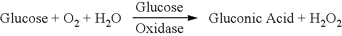

A glucose oxidase activity unit is defined as the amount of enzyme causing the oxidation of 1 micromole of glucose per minute at 25° C. at pH 7.0. Glucose oxidase for commercial use is also known as β-D-Glucopyranose aerodehydrogenase, DeeO™, Fermcozyme™, OxyBan™, and Ovazyme™. Glucose oxidase can be obtained for commercial purposes from Aspergilli and Penicillia. Isolation of glucose oxidase from Aspergillus niger is described in U.S. Pat. No. 3,102,081 (1963 to Miles Lab). Isolation of glucose oxidase from Penicillia cultures is described by Coulthard et al. in Biochem. J. 39, 24 (1945).

The amount of oxidoreductase enzyme that can be included in the dough product or the dough composition can be any amount that will be effective to react with and consume oxygen and prevent reaction of oxygen to produce discoloration of the dough composition. The particular amount used in a dough composition or dough product can depend on various factors, such as the type of dough composition and ingredients used in the dough composition, the type of dough product packaging (including the amount of headspace and the amount of oxygen in the headspace, if any), the amount of surface area of the dough product, the processing and packaging history of the dough product, the intended storage conditions of the dough composition or dough product, and how each of these and other factors affect the amount of oxygen present in a dough composition or a dough product. In particular, a dough composition or packaged dough product that may include relatively more oxygen may require relatively more oxidoreductase enzyme. A dough product that includes packaging with headspace, especially if the headspace contains an amount of oxygen, may require relatively more oxidoreductase enzyme compared to a dough product that includes packaging with less or no headspace or a dough product that includes headspace containing relatively less oxygen. The use of too much oxidoreductase enzyme can produce too much hydrogen peroxide reaction by-product. This in turn will cause the food product to discolor (e.g., yellow) because of the presence of too much hydrogen-peroxide. Too little glucose oxidase will mean that the oxygen levels will not be depleted quickly enough, causing the food product to discolor because of the presence of too much oxygen.

Exemplary amounts of glucose oxidase as an oxidoreductase enzyme, for use in chemically leavenable dough composition packaged in a flexible package with approximately 1 percent (by volume) oxygen in 35 cc of package headspace atmosphere, can be in the range from about 0.0025 glucose oxidase activity units per gram dough to about 0.25 glucose oxidase activity units per gram dough, e.g., from about 0.025 to about 0.075 glucose oxidase activity units per gram dough. A more specific example of glucose oxidase in a chemically leavenable dough composition is a package containing two 63 gm (each about 63 cubic centimeters) circular biscuit dough samples (2.875 inch diameter and 0.5 inch height) containing 0.025 glucose oxidase activity units per gram dough, packaged in a flexible film pouch (3.625 inch width and 7.25 inch length) with oxygen barrier properties equal to less than 1 cc O₂/100 square inches film over 24 hours @ 70° F., with 35 cc headspace atmosphere surrounding the biscuit dough samples within the pouch the composition of which is less than or equal to 1% oxygen (by volume). In terms of weight percent, an exemplary amount of glucose oxidase, e.g., GLUZYME 2.500 BG manufactured by Novozymes, can be about 0.001 weight percent of the total dough composition, which is equivalent to 0.025 glucose oxidase activity units per gram dough.

The reaction of glucose and oxygen, enzymatically catalyzed by an oxidoreductase enzyme (e.g., glucose oxidase), produces hydrogen peroxide as a reaction by-product. Hydrogen peroxide, at certain concentrations, can tend to produce a generally undesired yellowish discoloration of a dough composition. The invention optionally includes the use of an enzyme that reacts to degrade this hydrogen peroxide by-product in a dough composition, to reduce or prevent discoloration caused by the hydrogen peroxide.

Catalase is an enzyme that catalyses the decomposition of hydrogen peroxide into water and oxygen. Catalase is also known by the names Caperase, Equilase, and Optidase. The chemical reaction can be represented as follows:

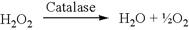

A catalase activity unit is defined as the amount of enzyme which under standard conditions of 25° C. and at pH 7.0 decomposes 1 micromole of H₂O₂ per minute. Catalase for commercial use is often obtained from animal liver, bacterial (Micrococcus lysodeikticus) and fungal (Aspergillus niger) sources. Methods of obtaining catalase are well known to those skilled in the art. Some of these methods are described, for example isolation from mammalian livers and kidneys, in U.S. Pat. No. 2,703,779 (1955 to Armour), and in Schroeder et al. Biochim. Biophys. Acta, 58, 611 (1962), isolation from Aspergillus niger in U.S. Pat. No. 3,102,081 (1963 to Miles Lab).

According to embodiments of the invention that involve the use of catalase and glucose oxidase, the following reaction occurs as a combined result of the two reactions above.

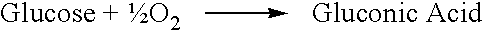

The amount of catalase that can be included in the dough product or the dough composition can be any amount that will be effective to react with and degrade hydrogen peroxide, to prevent discoloration of the dough composition that would be caused by the presence of hydrogen peroxide. The particular amount used in a dough composition or dough product can depend on various factors, such as those identified above with respect to useful amounts of oxidoreductase enzyme, e.g., the type of dough composition and ingredients, the type of packaging, processing and packaging considerations, the intended storage conditions of the dough composition or dough product, etc., as well as the amount of glucose and oxidoreductase enzyme that are present.

Exemplary amounts of catalase for use in chemically leavenable dough composition packaged in a flexible package with 35 cc headspace, can be in the range from 0 to about 25 catalase International Units per gram dough, e.g., from about 7.5 to about 20.6 catalase International Units per gram dough. A more detailed description of an exemplary application of catalase in a chemically leavenable dough composition would be two 63 gm circular biscuit dough samples (2.875 inch diameter and 0.5 inch height) containing 0.025 glucose oxidase activity units per gram dough and 15.6 catalase International Units per gram dough packaged in a flexible film pouch (3.625 inch width and 7.25 inch length) with oxygen barrier properties equal to less than 1 cc O₂/100 square inches film over 24 hours @ 70° F., with 35 cc headspace atmosphere surrounding the biscuit dough samples within the pouch, the composition of which is less than or equal to 1% oxygen (by volume).

A dough composition can be prepared according to methods and steps that are known in the dough and dough product arts. These can include steps of mixing, folding, lapping, adding ingredients, forming, shaping, cutting, rolling, etc., which are steps well known in the dough and baking arts. The dough composition can be packaged as desired, in a substantially air tight package that results in a dough product that can be stored at refrigerated storage temperatures (e.g., 35° F. to 50° F.), or at frozen storage temperatures (e.g., 5° F. to −10° F.). The package may include an internal pressure that is above atmospheric pressure, or that is at or below atmospheric pressure.

As an example, embodiments of packaged dough products of the invention can include a refrigerator stable raw dough product contained in a pressurized can or canister (typically having a pressure in the range from 10 to 20 pounds per square inch, gauge, which is from about 24 to 34 pounds per square inch, absolute), such as a spirally wound cardboard canister. These packages typically include little or no headspace, and expel oxygen upon proofing of a chemically leavenable dough composition inside of the package, which also creates the internal pressure. The dough composition may still include oxygen that might result in discoloration of the dough composition during storage, and as such, the use of an oxidoreductase enzyme (e.g., glucose oxidase) and optional catalase according to the present description can reduce or eliminate such discoloration.

As a further example, embodiments of packaged dough products according to the invention include refrigerator stable raw dough composition contained in a low pressure flexible package. A low pressure package can refer to a package that is substantially air tight and that will bulge if a gas such as carbon dioxide builds inside the packaging, but is not otherwise designed to produce or maintain a pressurized (greater than 1 atmosphere) interior space. The packaging material does not require and can preferably not include a pressure relief valve. Such low pressure flexible packages are sometimes used for packaging chemically leavenable dough compositions. These low pressure flexible packages typically include an amount of headspace, which may contain oxygen left inside during packaging. The amount of oxygen in the headspace may also be a result of oxygen entrained within and later evolved from the dough composition. According to preferred embodiments of the invention, the amount of oxygen present in the headspace may be reduced by purging the headspace with an inert gas, by reducing the amount of headspace (e.g., by use of vacuum), or both. Methods and packaged dough compositions that involve reduction of headspace are described, for example, in Applicants' copending U.S. patent application entitled “Packaged Dough Product in Flexible Package, and Related Methods,” having attorney docket number P5579-PIL0155/US, filed on even date herewith and incorporated herein by reference. According to such methods, a dough composition can be placed into a flexible package (e.g., when the dough composition is frozen) and headspace can be reduced. Upon subsequent storage, the dough composition can expand while inside of the package either to a larger proofed volume or to a volume that is at least large enough to accommodate a relatively smaller (e.g., non-proofing) amount of expansion of the dough composition that may result from carbon dioxide production by the dough composition that occurs during refrigerated or frozen storage.

Examples of low pressure packaged dough products can include any amount of dough composition, and preferably, the volume contained by the package is of the same order as the volume of the packaged dough composition. In terms of headspace for an exemplary packaged dough product, an example can be a packaged dough product containing two 63 gm circular biscuits (2.875 inch diameter and 0.5 inch height—each having a volume of approximately 63 cubic centimeters), each containing 0.025 glucose oxidase activity units per gram dough, packaged in a flexible film pouch (3.625 inch width and 7.25 inch length) with oxygen barrier properties equal to less than 1 cc O₂/100 square inches film over 24 hours @ 70° F., with 35 cc headspace atmosphere surrounding the biscuit dough samples within the pouch, the composition of which is less than or equal to 1% oxygen (by volume).

As another specific example, a packaged dough product can contain from about 20 to about 50 cubic centimeters headspace per 126 grams (e.g., 126 cubic centimeters) of dough composition, preferably from about 30 to about 40 cubic centimeters headspace per 126 grams dough composition. Alternatively, the amount of headspace (volume) can be substantially reduced by vacuum packaging such that the total amount of headspace atmosphere is minimized.

Advantageously, inclusion of oxidoreductase enzyme in the packaged dough product can eliminate at least a portion of an amount of oxygen that becomes present in a package headspace. Thus, the amount of oxygen in the headspace does not have to be reduced to the same degree as if the oxidoreductase enzyme were not used, while still preventing enzymatic discoloration of a dough composition. More specifically, if the amount of oxygen that may be tolerated in a headspace of a packaged dough product without the use of oxidoreductase enzyme is relatively low, e.g., equal to or below 0.5 percent by volume (as a total percent of 35 cc atmosphere surrounding two 63 gm biscuits with the dimensions of 2.875 inch diameter and 0.5 inch height), higher amounts of oxygen can be present in dough products of the invention without undue enzymatic discoloration. Exemplary amounts of oxygen that may be present in a headspace of a packaged dough composition, containing oxidoreductase enzyme, can also be below 0.5 percent by volume, but do not need to be that low, and may be greater than 0.5 percent by volume, e.g., up to 1 percent or even up to 2 percent by volume or potentially higher (as a total percent of 35 cc atmosphere surrounding two 63 gm biscuits with the dimensions of 2.875 inch diameter and 0.5 inch height) depending, e.g., on the amount of oxidoreductase enzyme present, e.g., the number of glucose oxidase activity units per gram dough.

The inventive methods and compositions can be used to prepare any type of dough compositions, and can be particularly useful for refrigerated dough compositions useful for preparing baked dough compositions including biscuits, bread sticks, crescent rolls, sweet rolls, etc.

The dough composition can be packaged and sold in a form that can be refrigerator stable. An example of a packaging configuration is a non-pressurized, substantially air-tight plastic tube or pouch containing individual portions of a dough composition such as biscuits. Any materials and techniques can be used for the packaging.

Optionally, embodiments of packaged dough products may include a carbon dioxide scavenger, e.g., as described in Assignee's U.S. patent application Ser. No. 10/273,668, filed Oct. 16, 2002, and entitled “Dough Composition Packaged in Flexible Packaging with Carbon Dioxide Scavenger,” the entire disclosure of which is incorporated herein by reference. The scavenger can reduce or prevent bulging of flexible packaging otherwise caused by carbon dioxide evolution, by absorbing amounts of carbon dioxide released by the dough composition during storage. The scavenger may be included in the packaged dough product in the form of a separate component such as a patch or sachet placed inside the package, or in the form of a scavenger material being included on or within a layer of a packaging material. As an example of the latter, a scavenger can be included as a filler or a suspended material in a polymeric matrix that is a part of a flexible packaging material of the packaged dough product. As another example, scavenger can be placed at an interior surface of a flexible packaging material, such as in the form of a coating that consists of or contains the scavenger. Useful scavengers can include metal oxides and metal hydroxides. A metal oxide can react with water to produce a metal hydroxide. The metal hydroxide can react with carbon dioxide to form water and a metal carbonate that will not cause flexible packaging to bulge. Example of scavengers may include calcium oxide or calcium hydroxide, magnesium oxide, barium oxide, potassium oxide (K₂O), and sodium oxide (Na₂O), etc.

A substantially air tight flexible package can be prepared from materials such as paper or polymeric materials, such as polymeric (e.g., plastic) film. A polymeric film may be prepared from generally known packaging material polymers such as different polyesters (e.g., PET), nylons, polyolefins (e.g., polyethylene), vinyls, polyalcohols, etc. A flexible packaging film may include only one or multiple layers, including two or more different layers that perform different functions including layers that act as a support layer, an oxygen barrier layer, a scavenger layer (polymer that includes scavenger), or a sealant layer. Flexible packaging materials that contain carbon dioxide scavenger materials are also described, for example, in Assignee's copending U.S. patent application docket number GMI P6196 (PIL0156/US), entitled “Multi-Layer Packaging Material with Carbon Dioxide Scavenger, Processes, and Packaged Food Products,” filed on even date herewith, the entire disclosure of which is incorporated herein by reference.

A particular embodiment of packaged dough product according to the invention can involve a packaged dough product that contains sub-divided packages containing one or multiple portions of dough composition packaged separately to include carbon dioxide scavenger, wherein the sub-packages are themselves contained together within a larger package to make up the packaged dough product. The smaller packaged dough products use low pressure (non-pressurized) packaging as described herein, which can make it easier (e.g., as opposed to pressurized cans often used with refrigerated dough products) to package fewer portions of dough composition, e.g., biscuits, in a single package, which in turn allows the advantage of portion control, i.e., less than all portions contained in a packaged dough product may be used together upon opening the packaged dough product.

As an example, a packaged dough product may include one or multiple portions of dough compositions packaged in a number of sub-divided units, e.g., a single packaged dough product may contain multiple smaller packages of 1, 2, or 3 portions of dough composition (e.g., biscuits), with each smaller package being substantially air tight but not pressurized. The smaller packaged dough product may contain 1, 2, 3, or any other number of dough portions such as a biscuit, convenient for a consumer to use at one time. This number of dough composition portions can be packaged with flexible packaging and according to the invention to include a carbon dioxide scavenger within the package to reduce or prevent bulging of the individual 1 or 2 or 3 portion-containing package. More than one of the smaller packaged units containing 1 or multiple dough composition portions can be included in a larger, non-pressurized package.

Preferred embodiments of the invention are described herein. Variations on the preferred embodiments will become apparent to those of skill in the relevant arts upon reading this description. The inventors expect those of skill to use such variations as appropriate, and intend for the invention to be practiced otherwise than specifically described herein. Accordingly, the invention includes all modifications and equivalents of the subject matter recited in the claims as permitted by applicable law. Moreover, any combination of the above-described elements in all possible variations thereof is encompassed by the invention unless otherwise indicated.

### EXAMPLE 1

### Effect of Total Moles of Oxygen in Package Headspace Gas on Low Pressure Biscuit Dough

A biscuit dough was prepared as follows.

Dough Formula and Process

| | | | |
|---|---|---|---|
| Ingredients | RMATL | % | gm |

Batch 1 size (gm): 15000

| | | | |
|---|---|---|---|
| flour, hard | | 36.1 | 5415 |
| flour, soft | | 9.02 | 1353 |
| water | | 18.81 | 2821.5 |
| ice | | 9.27 | 1390.5 |
| shortening chips* | | 12.72 | 1908 |
| buttermilk | | 2 | 300 |
| sucrose | | 2.25 | 337.5 |
| dextrose | | 2.25 | 337.5 |
| SALP | | 1.68 | 252 |
| Encapsulated soda | 110° F. mp, 60% active | 2.8 | 420 |
| salt | | 1.3 | 195 |
| sodium caseinate | | 1 | 150 |
| wheat protein isolate | | 0.2 | 30 |
| Cyrogel SG | Cold water soluble gelatin | 0.6 | 90 |
| SUB-TOTAL | | 100 | 15000 |

Batch 2 size (gm): 10000

| | | | |
|---|---|---|---|
| flour, hard | | 36.1 | 3610 |
| flour, soft | | 9.02 | 902 |
| water | | 18.81 | 1881 |
| ice | | 9.27 | 927 |
| shortening chips* | | 12.72 | 1272 |
| buttermilk | | 2 | 200 |
| sucrose | | 2.25 | 225 |
| dextrose | | 2.25 | 225 |
| SALP | | 1.68 | 168 |
| Encapsulated soda | 110° F. mp, 60% active | 2.8 | 280 |
| salt | | 1.3 | 130 |
| sodium caseinate | | 1 | 100 |
| wheat protein isolate | | 0.2 | 20 |
| Cyrogel SG | Cold water soluble gelatin | 0.6 | 60 |
| SUB-TOTAL | | 100 | 10000 |

Cryogel - manufactured by BP Gelatins of Phoenix, AZ.

Mixing (Spiral Mixer):

1. Combine all dry ingredients except shortening chips.

2. Add combined dries to mixer and mix 30 seconds slow speed.

3. Add liquids plus ice to mixer.

4. Mix 30 seconds slow speed followed by 120 seconds on high speed.

5. Add shortening chips.

6. Mix 30 seconds slow speed followed by 120 seconds high speed.

Target dough temperature 55-60° F.

Sheeting: (3 sheetings for 15 Kg batch, 2 sheetings for 10 Kg batch)

7. Sheet 5000 gm dough pad to approximately 13.5 mm: do a three fold and turn 90°; sheet to 13.5 mm

8. Cut biscuits with 3″ cutter to 63+/−3 gm

Packaging

9. Make 20 (two biscuit) pouches per each sheeting.

(Pouch=Nylon film with EVOH O2 barrier and LDPE sealant.

Pouched sized to 4.5″×8.75″ upon sealing after flushing with gas).

10. Flush pouches with designated gas mixture (see tables below).

| Batch # | Sheeting # | % O2* | # Pouches |
|---|---|---|---|
| 1 | 1 | 5 | 20 |
| 1 | 2 | 2 | 20 |
| 1 | 3 | 1 | 20 |
| 2 | 4 | 0.5 | 20 |
| 2 | 5 | 0.25 | 20 |

| Gas mixtures* | % O2 | % N2 |
|---|---|---|
| 1 | 5 | 95 |
| 2 | 2 | 98 |
| 3 | 1 | 99 |
| 4 | 0.5 | 99.5 |
| 5 | 0.25 | 99.75 |

All biscuit pouches were stored at 45° F. and evaluated for color after 0, 2, 4, 6, 8, and 10 weeks storage, using a Minolta Colorimeter.

The packaged biscuit dough was studied over a period of time to determine the development of color over time relative to the percentage/micromoles of oxygen present in the packaging. The results are tabulated in the following table.

| | | | Volume | | | | | |
|---|---|---|---|---|---|---|---|---|
| | Packaging | Headspace | of O₂ in | | | | | |
| % O₂ in | Volume | Volume | headspace | Pressure | Temp | R (joules/ | | Micromoles |
| headspace | (cc)² | (cc)³ | (cc)⁴ | (KPa)⁵ | (K)⁶ | mol * K)⁷ | n (moles O₂)⁸ | O₂⁹ |
| 4.8 | 313.74 | 187.74 | 9.01152 | 101.325 | 280.37 | 8.314 | 0.000391718 | 391.7176 |
| 2.1 | 266.2 | 140.2 | 2.9442 | 101.325 | 280.37 | 8.314 | 0.00012798 | 127.9801 |
| 1.1 | 268.2 | 142.2 | 1.5642 | 101.325 | 280.37 | 8.314 | 6.7994E−05 | 67.9935 |
| 0.45 | 251.95 | 125.95 | 0.566775 | 101.325 | 280.37 | 8.314 | 2.4637E−05 | 24.6369 |
| 0.18 | 255.4 | 129.4 | 0.23292 | 101.325 | 280.37 | 8.314 | 1.0125E−05 | 10.1247 |

¹% Oxygen by volume, measured in Headspace
²Total measured packaged volume (cc)
³Headspace gas volume: total package volume − biscuit volume of 127 cc
⁴Volume of O₂ in headspace gas = (% Oxygen in packaged Headspace/100) * (Headspace volume)
⁵Pressure = 1 atmosphere expressed in kilopascals
⁶Temperature expressed in Kelvins
⁷R = universal gas constant
⁸n = moles of headspace gas Oxygen calculated employing PV = nRT
⁹conversion of moles of O₂ into micromoles O₂ (1 mole = 10⁶ micromoles)
(The samples containing 1.1, 2.1, and 4.8 percent by volume O₂ in headspace were considered to become gray, while samples containing 0.45 and 0.18 percent by volume O₂ were not.)

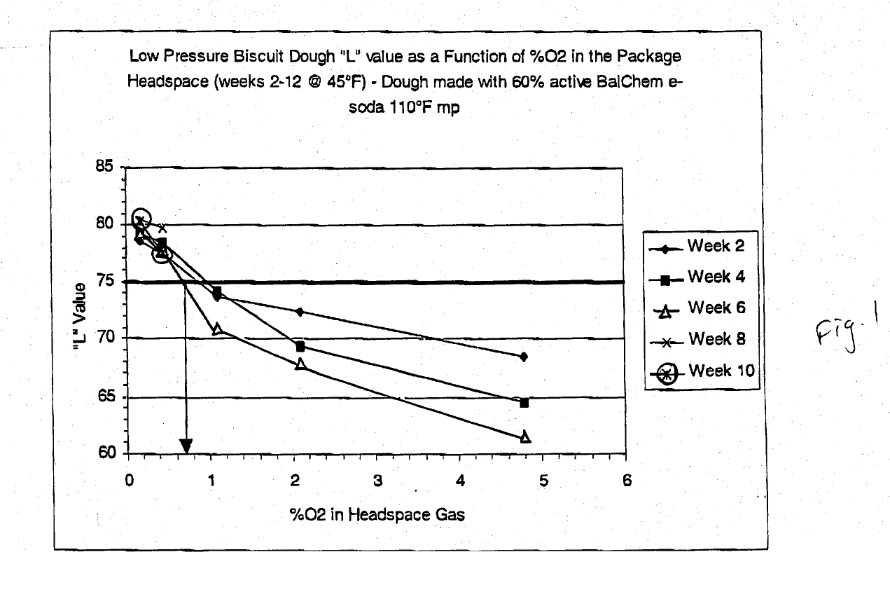

From the Table it can be seen that when the headspace gas contained at least 1.1% by volume oxygen, the low pressure refrigerated biscuit dough became visibly gray after determination using the colorimeter. When package headspace gas contained less than or equal to 0.45% by volume oxygen, the low pressure refrigerated biscuit dough did not become visibly gray. Based on these results and assuming a linear relationship between % headspace oxygen concentration and gray dough color development, one can conclude that low pressure refrigerated dough color would not change perceptibly at headspace oxygen concentrations of less than 0.64% (by volume). These results are illustrated graphically over a number of weeks in FIG. 1.

The “L” color value is a measure of light (high L value) to darkness (low L value). At an “L” value of less than 75 one can visually detect a change in dough color (i.e., dough graying). The lower the L value the grayer the dough.

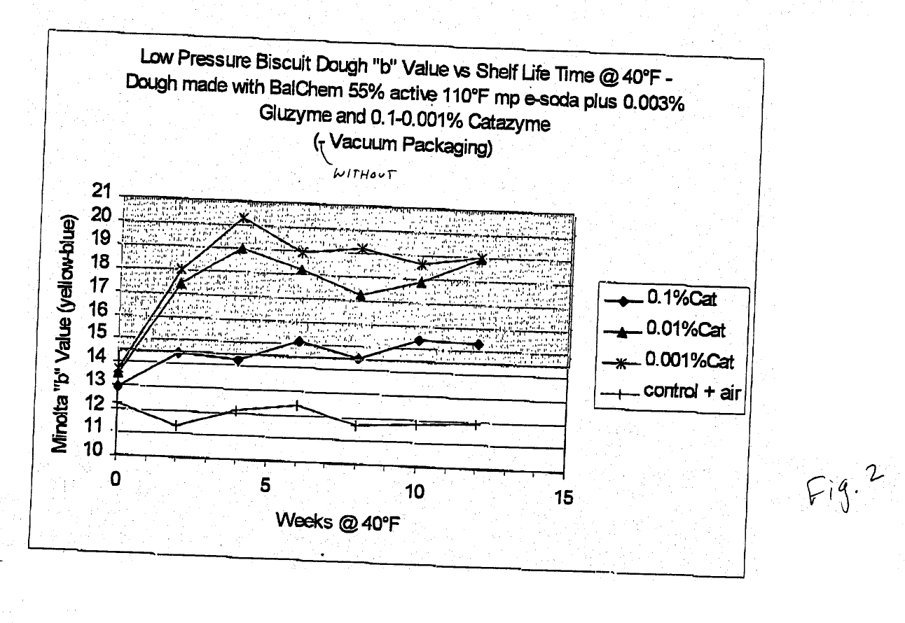

If the threshold of % oxygen in the headspace of 0.64% is converted into micromoles of oxygen, then this equates to a minimum of 40 micromoles of oxygen. In other words the minimum number of micromoles of oxygen resulting in gray dough color development in the two 63 gm biscuits was equal to 40. This result is illustrated graphically for a number of weeks in FIG. 2.

The percentage of oxygen concentration is a relative measure with respect to graying that arises from polyphenol oxidase activity. Polyphenol oxidase graying is the result of pigment formation on the surface of a dough product, which is a function of

The number of moles of oxygen in the package headspace,

The exposed surface area of the dough,

The concentration of polyphenol oxidase in the dough, and

The pH of the dough. The more alkaline the dough pH, the greater the rate and extent of enzymatic graying.

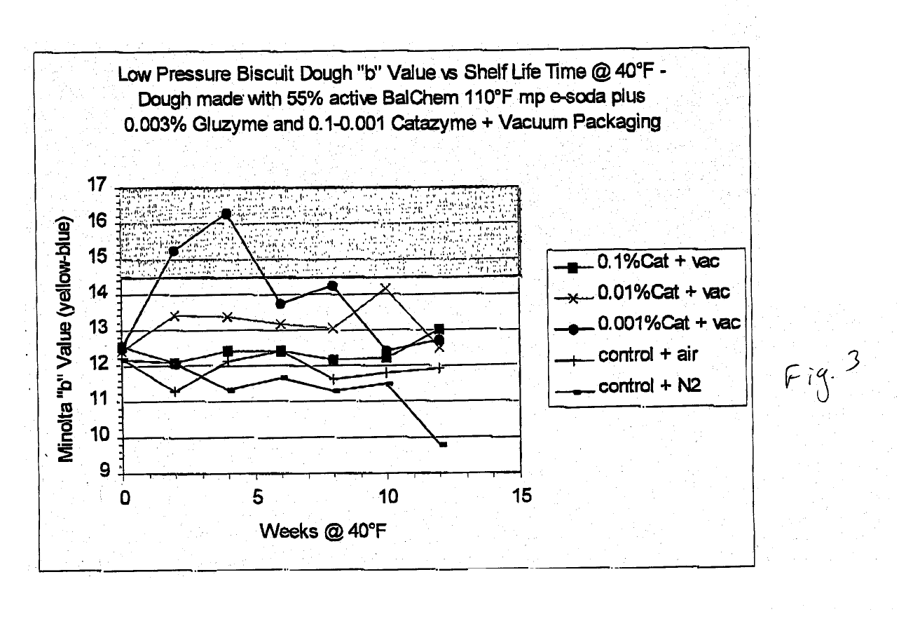

The minimum number of micromoles of oxygen resulting in gray dough color formation divided by the biscuit dough surface area (40.0 micromoles/190.64 cm²) gives a minimum threshold of 0.21 micromoles of oxygen/cm² dough surface that will result in gray dough color formation at dough pH values less than or equal to 6.5. Polyphenol oxidase graying of the biscuit dough occurred fairly rapidly at 45° F. Typically, it has been found that the majority of the color change occurs within the first two weeks of storage. These results are illustrated graphically in FIG. 3.

### EXAMPLE2

### Effect of Glucose Oxidase and Catalase Addition on Low Pressure Refrigerated Dough Performance Against Shelf Life Time

A biscuit dough prepared as outlined in Example 1 was further studied with respect to the effect of the ratio of glucose oxidase/catalase on low pressure refrigerated biscuit dough color change against storage time. The headspace oxygen concentration, dough color change, and product bake performance were studied over time. In this example the glucose oxidase and catalase were intimately mixed into the biscuit dough. All the studies were carried out at 45° F.

Dough Formula and Process

Batch size (gm): 10000

| Ingredients | RMATL | % | gm |
|---|---|---|---|
| flour, hard | | 36.1 | 3610 |
| flour, soft | | 9.02 | 902 |
| water | | 18.81 | 1881 |
| ice | | 9.27 | 927 |
| shortening chips | | 0 | 0 |
| buttermilk | | 2 | 200 |
| sucrose | | 2.25 | 225 |
| dextrose | | 2.25 | 225 |
| SALP | | 1.68 | 168 |
| Encapsulated soda | 110° F. mp, | 3.05 | 305 |
| | 55% active | | |
| salt | | 1.3 | 130 |
| sodium caseinate | | 1 | 100 |
| wheat protein isolate | | 0.2 | 20 |
| Cyrogel SG | Cold water | 0.6 | 60 |
| | soluble | | |
| | gelatin | | |
| SUB-TOTAL | | 87.53 | 8753 |

| | % | gm |
|---|---|---|
| Run 1 | | |
| Gluzyme 2.500 BG | 0.0031584 | 0.31584 |
| (manufactured by | | |
| Novozymes, Franlinton, | | |
| NC) | | |
| Catazyme 25L | 0.1 | 10 |
| (manufactured by | | |
| Novozymes, Franlinton, | | |
| NC) | | |
| shortening chips | 12.37 | 1237 |
| Run 2 | | |
| Gluzyme | 0.0031584 | 0.31584 |
| Catazyme | 0.01 | 1 |
| shortening chips | 12.46 | 1246 |
| Run 3 | | |
| Gluzyme | 0.0031584 | 0.31584 |
| Catazyme | 0.001 | 0.1 |
| shortening chips | 12.47 | 1247 |
| Run 4 (control) | | |
| Gluzyme | 0 | 0 |
| Catazyme | 0 | 0 |
| shortening chips | 12.47 | 1247 |

Enzyme Unit Calculations

| Run | Enzyme | Units/gm | Units in Dough |
|---|---|---|---|
| 1 | Gluzyme 2500 BG | 3000 | 947.52 |
| | Catazyme 25L | 26625 | 266250 |
| 2 | Gluzyme 2500 BG | 3000 | 947.52 |
| | Catazyme 25L | 26625 | 26625 |
| 3 | Gluzyme 2500 BG | 3000 | 947.52 |
| | Catazyme 25L | 26625 | 2662.5 |

Mixing (Large Spiral Mixer):

1. Combine all dry ingredients except shortening chips and e-soda.

2. Add combined dries to mixer and mix 30 seconds slow speed.

3. Mix catazyme into water.

4. Add liquids plus ice to mixer.

5. Mix 30 seconds slow speed followed by 120 seconds on high speed.

6. Cut dough and add shortening chips and e-soda.

7. Mix 30 seconds slow speed followed by 120 seconds high speed.

Target dough temperature 55-60° F.

Sheeting:

7. Sheet dough pad to approximately 13mm: do a three fold and turn 90°; sheet to 13 mm

8. Cut biscuits eith 3″ cutter to 63+/−3 gm

Packaging

9. Package 40 (two biscuit) cups from runs 1-3 (air in headspacr/no flush).

10. Collapse sample headspace for 20 of the 40 samples packaged for 1-3.

Use needle attached to house vacuum (puncture through septum attached to cup lid, reseal with a second septum).

Apply just enough vacuum to collapse the packaged against the biscuit dough (too much vacuum will deform the product).

11. Flush and seal 20 control (run 4) sample cups with N2 gas.

12. Package 20 control (run 4) sample cups in air.

The packaged biscuit dough was studied over a period of time to determine the development of color over time relative to the percentage/micromoles of oxygen present in the packaging. The results are tabulated in the following table.

| | Package | V | | % O₂ in | | | Micromol | | |
|---|---|---|---|---|---|---|---|---|---|
| Dough | volume | (cc- | n (mole | headspace | Micromol | (cc | of O₂/cm² | Gray | Yellow |
| type | (cc)¹ | HS)² | (O₂)³ | gas⁴ | O₂)⁵ | (O₂)⁶ | dough⁷ | color⁸ | color⁹ |
| 0.1% cat | 181.05 | 550.5 | 5.02 × 10⁻⁴ | 20.79 | 502.49 | 11.44 | 2.64 | − | +/− |
| 0.1% cat + vac | 130.7 | 4.7 | 4.29 × 10⁻⁵ | 20.79 | 42.90 | 0.98 | 0.23 | − | − |
| 0.01% | 181.15 | 55.15 | 5.03 × 10⁻⁴ | 20.79 | 503.4 | 11.47 | 2.64 | − | + |
| cat | | | | | | | | | |
| 0.01% | 131.15 | 5.15 | 4.7 × 10⁻⁵ | 20.79 | 47.01 | 1.07 | 0.25 | − | − |
| cat + vac | | | | | | | | | |
| 0.001% | 179.8 | 53.8 | 4.91 × 10⁻⁴ | 20.79 | 49.08 | 11.19 | 2.58 | − | + |
| cat | | | | | | | | | |
| 0.001% | 137.3 | 11.3 | 1.03 × 10⁻⁴ | 20.79 | 103.15 | 2.35 | 0.54 | − | + |
| cat + vac | | | | | | | | | |
| Control | 179.45 | 53.45 | 4.88 × 10⁻⁴ | 20.79 | 487.89 | 11.11 | 2.56 | + | − |
| (air) | | | | | | | | | |
| Control | 181.9 | 55.9 | 4.42 × 10⁻⁶ | 0.18 | 4.42 | 0.1 | 0.02 | − | − |
| N₂ flush | | | | | | | | | |

PV = nRT calculation values P (KPa) = 101.325 R (joule/mol * K) = 8.314 T (K) = 277.58
¹Total measured package volume (cc)
²Headspace gas volume: total package volume − biscuit volume of 127 cc at time zero
³n = moles of headspace gas oxygen calculated employing PV = nRT
⁴% Oxygen measured in Headspace gas (air = 20.79%, flushed = 0.18%)
⁵Conversion of mols oxygen into micromoles oxygen (1 mole = 10⁶ micromoles)
⁶Volume of O² in headspace gas = (% Oxygen in packaged Headspace/100) * (Headspace volume)
⁷Micromoles oxygen in package headspace/surface area of biscuit dough
⁸Dough visually appears gray (Minolta L value less than 75)
⁹Dough visually appears yellow (Minolta b value greater than 14.5)

The Minolta “b” value axis of the CIE color space is a measure of yellow to blue. The larger the “b” value, the more yellow the sample. We have found that a biscuit Minolta “b” value of >14-15 possess a detectable yellow hue.

The above results show that the addition of glucose oxidase to refrigerated dough prevents gray dough color development by effectively removing oxygen from the dough package system. Accumulation of hydrogen peroxide by the action of glucose oxidase will cause the dough to yellow. When catalase is added to the dough in combination with glucose oxidase, the catalase enzyme will delay and/or prevent yellow dough color development if the catalase concentration is high enough and the number of moles of oxygen present in the product/package system is sufficiently small.

It was observed that the percent oxygen in the package headspace of dough containing glucose oxidase and catalase decreased fairly rapidly within the first few days of storage. After two weeks storage the percentage of oxygen in the dough headspace was significantly lower than that of the control sample packaged in air.

All dough samples to which the combinations of glucose oxidase and catalase system were added (in addition to the flushed N₂ control sample) did not visibly gray over the 12 week period. The reduction of headspace gas did not visibly affect the dough color. Glucose oxidase therefore was effectively removing oxygen from both the vacuumed and non-vacuumed package headspace. The control dough packaged in air and without the enzyme combination became gray within two weeks.

The addition of catalase in low concentrations (0.001%) and (0.01%) allowed the dough to become visibly yellow as a result of the accumulation of H₂O₂ within two weeks of storage. At the higher concentration of 0.1%, the catalase level was high enough to effectively prevent the dough from yellowing over the initial 5-6 week period. Better results were observed when the headspace of the package was evacuated to reduce the total amount of oxygen present in the headspace. Results are illustrated in FIGS. 2 and 3. FIG. 3 shows that at 0.001% catalase, the recorded Minolta “b” value indicated that the dough became visibly yellow between weeks 2-4 (b greater than 14.5) but was not detectably yellow between weeks 6-8 (b less than 14.5). A possible explanation for this result is that the 0.001% catalase biscuit dough sample displayed only localized regions of discoloration along the biscuit edge in the region where the measurement was taken. Overall, the 0.001% catalase samples did not appear noticeably yellow in color over the 12 week study period. These results show that the evacuated dough/package system with both glucose oxidase and 0.001%-0.1% catalase are particularly effective to prevent both polyphenol oxidase graying and dough yellowing due to H₂O₂ accumulation.

In terms of the results measuring the sample cup volume of the low pressure biscuit dough package, it was observed that all samples experienced a 1-30 ml increase in package volume over the 12 week period. This is equivalent to a 5-15 ml carbon dioxide out gassed per 63 gm of biscuit. Interestingly the vacuum packaged sample set displayed a 10-20 ml increase in package volume while samples packaged without vacuum packaging experienced a slightly higher 20-30 ml increase in package volume over shelf life time. All packages samples displayed an 8-20 ml increase in volume over the first 2 weeks of storage then stabilized (or increased only slightly) over the remaining 10 weeks of the study. Compared to the control sample sets that did not contain the enzyme combination, the addition of the enzyme combination had no measurable effect on package volume change against the shelf life time.

The carbon dioxide out-gassing profiles of the non vacuum packaged systems were studied. The four studied systems all out-gassed carbon dioxide over the initial 4 weeks before stabilizing. Interestingly, the control dough out gassed approximately 30% carbon dioxide while the glucose oxidase and catalase combination systems out gassed 35% at 0.001% catalase and approximately 42% at 0.01% and 0.1% catalase. As the catalase concentration increased from 0-0.01%, so did the percentage of carbon dioxide out gassed.

The series of studies also focused on the effect on the pH of the dough over shelf life time with the various systems. Dough pH declined in all samples from approximately 5.8 at time zero to 4.3 after 4 weeks of storage. From this study it is possible to conclude that the enzyme combination with or without the vacuum packaging does not affect the dough pH.

The series of studies also focused on the effect on the Baked Specific Volume (BSV) of the dough over shelf life. It was observed that the BSV increased with shelf life time from 2.6-2.75 at time zero to 2.9-3.1 after 12 weeks of storage. Addition of the enzyme combination appeared to enhance the biscuit BSV with shelf life time compare to the controls that did not contain the enzyme combination. It was also noted that vacuum packaging had no effect on the measured BSV volume.

What is claimed is:

1. A dough product comprising raw dough inside a package, the dough product comprising an oxidoreductase enzyme and a substrate that reacts with oxygen in the presence of the oxidoreductase enzyme, in amounts to consume oxygen to inhibit enzymatic discoloration of the dough.

2. The dough product of claim 1 wherein the dough exhibits a Minolta “L” color value of greater than 75 after storage for 2 weeks at 40 degrees Fahrenheit.

3. The dough product of claim 1 wherein the substrate is glucose and the enzyme is glucose oxidase.

4. The dough product of claim 3 comprising 0.0025 to 0.25 glucose oxidase activity units per gram dough.

5. The dough product of claim 3 comprising a sufficient amount of catalase to inhibit discoloration of the dough due to the presence of hydrogen peroxide.

6. The dough product of claim 1 wherein the dough is a refrigerator stable, proofed or unproofed dough packaged in flexible or rigid packaging that contains headspace.

7. The dough product of claim 6 wherein the headspace contains less than 2 micromoles O₂ per square centimeter dough surface area.

8. A chemically leavenable dough comprising an oxidoreductase enzyme and a substrate that reacts with oxygen in the presence of the oxidoreductase enzyme, packaged in a low pressure container.

9. The dough of claim 8 wherein the oxidoreductase enzyme is glucose oxidase and the substrate is glucose.

10. The dough of claim 9 comprising 0.0025 to 0.25 glucose oxidase activity units per gram dough.

11. The dough of claim 9 wherein the packaged dough comprises headspace containing less than 2 micromoles O₂ per square centimeter dough surface area.

12. The dough composition of claim 11 wherein the packaged dough comprises headspace containing less than 2 percent by volume oxygen.

13. The dough of claim 8 comprising catalase.

14. The dough of claim 13 comprising 7.5 to 20.6 catalase International Units per gram dough.

15. The dough of claim 8 comprising chemical leavening agents comprising an encapsulated basic chemical leavening agent and a non-encapsulated acidic chemical leavening agent.

16. The dough of claim 15 wherein the non-encapsulated acidic chemical leavening agent comprises sodium aluminum phosphate.

17. The dough of claim 8 wherein the low pressure container contains from 30 to 40 cubic centimeters headspace per 126 cubic centimeters dough.

18. A method of preparing a packaged dough product, the method comprising
providing a dough composition comprising water, flour, and leavening agent, and
including oxidoreductase enzyme in the dough product and a substrate that reacts with oxygen in the presence of the oxidoreductase enzyme, to consume oxygen and inhibit discoloration of the dough due to enzymatic oxidation.

19. The method of claim 18 comprising placing the dough composition into a package selected from a flexible package and a canister.

20. The method of claim 18 wherein the package is a flexible package, the method comprising reducing headspace volume in the package to below 2 percent by volume of the combined product and package volume.

21. The method of claim 18 comprising flushing the package with nitrogen.

22. The method of claim 18 wherein the method excludes a step of flushing the package with nitrogen.

23. The method of claim 18 comprising storing the dough at refrigeration temperature.

24. The method of claim 18 wherein the dough composition comprises glucose and glucose oxidase.

25. The method of claim 18 comprising topically applying oxidoreductase enzyme to a surface of the dough composition.
